(19) United States
(12) Patent Application Publication
(10) Pub. No.: US 2025/0347169 A1
(43) Pub. Date: Nov. 13, 2025

(54) LIGTHWEIGHT FORCED-ENTRY AND BULLET-RESISTANT DOOR AND BULLET-RESISTANT PANEL

(71) Applicant: R2P Innovations, LLC, Ladson, SC (US)

(72) Inventor: Anthony Deering, Daniel Island, SC (US)

(73) Assignee: R2P Innovations, LLC, Ladson, SC (US)

(21) Appl. No.: 18/656,700

(22) Filed: May 7, 2024

(51) Int. Cl. E06B 5/10; B32B 3/26; B32B 7/12; B32B 15/10; B32B 15/18; C22C 38/00; C22C 38/02; C22C 38/06; C22C 38/42; C22C 38/44; C22C 38/46; C22C 38/58; F41H 5/04; F41H 5/24

(52) U.S. Cl. CPC E06B 5/106; B32B 3/266; B32B 7/12; B32B 15/10; B32B 15/18; C22C 38/002; C22C 38/02; C22C 38/06; C22C 38/42; C22C 38/44; C22C 38/46; C22C 38/58; F41H 5/0442; F41H 5/24; B32B 2307/558; B32B 2571/02; B32B 2605/00

(57) ABSTRACT

A bullet-resistant door utilizing a secured edge layered assembly substantially defining an inner perimeter of the door, and a bullet-resistant panel secured internal to the door using the secured edge layered assembly. The bullet-resistant door has a minimum UL 752—Level 8 protection rating and has a significantly lower weight relative to conventional bullet-resistant doors and can be manufactured to fit within any sized commercial door frame.

### FIELD OF INVENTION

The present invention provides a forced-entry and bullet-resistant door and a bullet-resistant panel for mitigating the penetration of high velocity bullets or other projectiles fired at such a door or a panel. The present invention utilizes a hybrid metallic bullet-resistant core panel for use in the forced-entry and bullet-resistant door. The present invention also provides a unique method of manufacturing for mitigating the kinetic energy of high-velocity projectiles such as military grade rifle ammunition. The present invention also provides a method of manufacturing that ensures longevity and stability in the final door or panel product.

### BACKGROUND

A forced-entry and bullet-resistant (“FEBR”) door is intended to provide protection to persons by creating a safe haven in the event of an armed assault from an external threat. Such a door is intended to provide a bullet-resistant entry door for the room. In recent years, there have been ever increasing incidents involving loss of life when individuals armed with firearms have entered buildings such as schools, universities, commercial buildings, government offices, hospitals and malls, killing people in those locations, including those intending to take refuge in different rooms. Additionally, the owners of residences in certain unsafe areas or owners that are at greater risk of facing armed individuals in their residence, such as prosecutors, government officials, and individuals in the public eye, have installed so-called “safe rooms” at an increasing frequency. As a result, there is a significant need for forced-entry and bullet-resistant security doors or FEBR security doors that can be used to create secure rooms in places such as malls and other commercial buildings, government offices, hospitals, schools and universities, and to act as the entry door for safe rooms in residences.

Conventional forced-entry and bullet-resistant doors are extremely heavy and inappropriately sized to fit within conventional door frames. Conventional FEBR doors require substantial upgrades in door hardware and custom manufactured door frames to support the increase in weight. Additionally, the weight and size of the conventional bullet-resistant doors make the doors more difficult to open and close. Since special hardware and door frames are conventionally required, it is very difficult and expensive to retrofit a building with bullet-resistant security doors to replace pre-existing non-bullet-resistant doors. The heavier weight of the conventional bullet-resistant doors also impacts hardware wear and tear, product lifecycle, and cost of ownership. The total weight of the conventional bullet-resistant door also impacts the freight and shipment costs of raw components as well as the finished door shipment cost.

There is a long-felt need for a security door that is bullet-resistant, yet is light weight, easy to manufacture, and can be easily retrofit into existing doorframes, providing high levels of protection from high velocity rifle ammunition, breach assaults, and other security threats.

### SUMMARY OF INVENTION

The present invention relates to a lightweight forced-entry and bullet-resistant door specifically designed for protecting against mechanical breach assaults and threats from armed assailants using high velocity, military grade rifles. Without intending to be bound by theory, the forced-entry and bullet-resistant door and panel of the invention offers improved protection, but at significantly reduced weight in comparison to conventional forced-entry and bullet-resistant doors and panels. The FEBR door and FEBR panel of the invention are specifically designed to combat the threat of high velocity military grade rifle ammunition and is rated at Level 8 on the UL 752 ballistic protection scale. The FEBR doors of the invention have also been extensively tested by the US Department of State, Bureau of Diplomatic Security and have attained high level of certification at 15R FEBR for a wooden door, DOS SD-STD-01.01 Rev H, 15 minute forced entry and rifle stopping protection level.

An innovative, hybrid, ultra-lightweight metallic panel is sandwiched between shock absorbing natural materials that when layered together stop the penetration and associated shock and spall produced by high velocity rifle ammunition, specifically 7.62 mm×51 mm full metal jacketed rifle rounds with the military designation M80.

An aspect of the invention provides a bullet-resistant panel encapsulated in a layered assembly of shock-mitigating natural materials and framed by pre-machined high strength metallic strips. According to an embodiment of the invention, the bullet-resistant door has, at a minimum, UL 752—Level 8 protection rating and a UL 752—Level 8 protection in other embodiments of the invention.

In an embodiment of the invention, the bullet-resistant door has a shock-mitigating layer and a diametrically opposed shock-mitigating layer covering both sides of the bullet-resistant panel, the shock-mitigating layer and diametrically opposed shock-mitigating layer have a low-density balsa according to certain embodiments of the invention. In an embodiment of the invention, the shock-mitigating low-density balsa and the diametrically opposed shock-mitigating low-density balsa are adhesively bonded to the bullet-resistant panel. In other embodiments of the invention, the shock-mitigating low-density balsa and the diametrically opposed shock-mitigating low-density balsa are each surrounded by a structural natural material.

In other embodiments of the invention, the bullet-resistant door additionally has a lite. Further pursuant to this embodiment of the invention, the bullet-resistant door additionally has an aperture where a bullet-resistant glass is inserted to define the lite.

Optionally, the bullet-resistant door of the invention may incorporate a protected window. Further pursuant to this embodiment of the invention, the bullet-resistant door comprises an aperture where a bullet-resistant glass is inserted to define the lite.

In still other embodiments of the invention, the bullet-resistant door of claim 1, has a panel and a diametrically opposed panel each having a veneer layer. Further pursuant to this embodiment of the invention, the veneer layer comprises a crossband veneer layer having a second layer of veneer under a top layer of veneer with the grains of the second layer of veneer running opposite to the top layer of veneer.

In yet other embodiments of the invention, the bullet-resistant door additionally comprises soft wood layers encapsulating both sides of the bullet-resistant panel. Further pursuant to this embodiment of the invention, the soft wood layers may be adhesively bonded to the bullet-resistant panel.

Another aspect of the invention provides a bullet-resistant door having a bullet-resistant panel constructed of a material comprising a manganese steel including from about 9 wt % to about 30 wt % manganese (Mn) and from about 1 wt % to about 4 wt % aluminum (Al). In certain embodiments of the invention, the manganese steel may additionally have any one of or any combination of up to about 6 wt % of silicon (Si), up to about 4 wt % copper (Cu), up to about 4% nickel (Ni) and up to about 1 wt % carbon (C), and the remainder of the manganese steel comprises an iron alloy.

In an embodiment of the invention, the bullet-resistant door has a bullet-resistant panel comprising a plurality of layers including a front-face bullet-resistant layer and a backing layer where the two layers joined via metallurgical bonding that includes a metallic based intermediate layer. In certain embodiments of the invention, the plurality of layers are joined by using in one of or any combination of a wide-area weld, an explosive cladding, and roll weld.

In certain embodiments of the invention, the front-face antiballistic layer is a hybrid metallic alloy comprising about 0.66 wt % of carbon, about 0.40 wt % of silicone, about 0.40 wt % of manganese, no more than about 0.010 wt % of phosphorus, no more than about 0.010 wt % of sulfur, about 1.20 wt % of chromium, about 0.20 wt % of nickel, about 0.20 wt % of vanadium, about 1.90 wt % of tungsten with the remainder being an iron alloy.

In other embodiments of the invention, the backing protective layer is a metallic alloy comprising 0.30 wt % of carbon, 1.60 wt % of silicone, 1.40 wt % of manganese, no more than about 0.010 wt % of phosphorus, no more than about 0.008 wt % of sulfur, 0.40 wt % of chromium, 1.20 wt % of nickel, the remainder is an iron alloy.

In still other embodiments of the invention, the metallic based intermediate layer has a face-centered cubic crystalline lattice construction comprising alloys about 71.0 wt % of nickel, about 16.0 wt % of chromium, about 3.0 wt % of manganese, about 1.0 wt % of molybdenum, about 2.0 wt % of niobium, about 6.0 wt % of iron.

In yet another aspect, the invention provides a layered assembly substantially defining an inner perimeter of the panel, where the layered assembly having a bullet-resistant panel secured internally using the using layers of shock-mitigating materials, pre-machined wood panels and door veneers having at least UL 752—Level 6 protection.

Still another aspect of the invention provides, a method of manufacturing a bullet-resistant door comprising the steps of providing a bullet-resistant panel, securing both sides of the bullet-resistant panel with a shock-mitigating low-density balsa wood, encapsulating the bullet-resistant panel and shock-mitigating low-density balsa wood between the two pre-machined wooden faces of the door, securing both of the top and bottom edges using a pre-machined high strength metallic strips thus providing the doors with additional edge strength and anti-breach protection, and finishing the bullet-resistant door with a laminated skin, wherein the bullet-resistant door provides a minimum UL 752—Level 8 protection.

In an embodiment of the invention, the method of manufacturing a bullet-resistant door additionally includes the step of inserting a bullet-resistant glass in an aperture of the bullet-resistant door to define a lite.

Other aspects and embodiments will become apparent upon review of the following description taken in conjunction with the accompanying drawings. The invention, though, is pointed out with particularity by the included claims.

### BRIEF DESCRIPTION OF THE DRAWINGS

Having thus described the invention in general terms, reference will now be made to the accompanying drawings, which are not necessarily drawn to scale, and wherein:

FIG. 1 is a plane view of a panel of the bullet-resistant door, according to an embodiment of the invention;

FIG. 2 is a perspective, deconstructed view of the assembly of a bullet-resistant door, according to an embodiment of the invention;

FIG. 3 is a cross-sectional view taken along line 3-3 in FIG. 1 showing interlayer construction of the bullet-resistant door, according to certain embodiments of the invention;

FIG. 4 is a three-dimensional view of a bullet-resistant panel according to an embodiment of the invention;

FIG. 5 is a plane side view of a bullet-resistant panel according to an embodiment of the invention; and

FIG. 6 is a side view of a latch edge of a bullet-resistant panel according to an embodiment of the invention.

### DETAILED DESCRIPTION OF THE INVENTION

The present invention now will be described more fully hereinafter with reference to the accompanying drawings, in which some, but not all embodiments of the inventions are shown. Preferred embodiments of the invention may be described, but this invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments of the invention are not to be interpreted in any way as limiting the invention.

As used in the specification and in the appended claims, the singular forms “a”, “an”, and “the” include plural referents unless the context clearly indicates otherwise. For example, reference to “a bullet-resistant metal” may include a plurality of such bullet-resistant metals.

It will be understood that relative terms may be used herein to describe one element's relationship to another element as, for example, may be illustrated in the Figures. It will be understood that relative terms are intended to encompass different orientations of the elements in addition to the orientation of elements as illustrated in the Figures. It will be understood that such terms can be used to describe the relative positions of the element or elements of the invention and are not intended, unless the context clearly indicates otherwise, to be limiting.

Embodiments of the present invention are described herein with reference to various perspectives, including, for example, perspective views that are representations of idealized embodiments of the present invention. As a person having ordinary skill in the art would appreciate, variations from or modifications to the shapes as illustrated in the Figures or the described perspectives are to be expected in practicing the invention. Such variations and/or modifications can be the result of manufacturing techniques, design considerations, and the like, and such variations are intended to be included herein within the scope of the present invention and as further set forth in the claims that follow. The articles of the present invention and their respective components described or illustrated in the Figures are not intended to reflect a precise description or shape of the component of an article and are not intended to limit the scope of the present invention.

Although specific terms are employed herein, they are used in a generic and a descriptive sense only and not for purposes of limitation. All terms, including technical and scientific terms, as used herein, have the same meaning as commonly understood by one of ordinary skill in the art to which this invention belongs unless a term has been otherwise defined or differs from that meaning based upon how the term is used herein in the description of the invention. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

As used herein, a “bullet-resistant door” and a “bullet-resistant panel” refers to a door and a panel, respectively, that meets or exceeds certain United Laboratories (UL) 752 Specifications and Ammunition, 11th Edition, Standard for Bullet Resisting Equipment. In one embodiment of the invention, the bullet-resistant door and bullet-resistant panel meets or exceeds UL 752 −Level 8, which provides, in a non-limiting example, protection against multiple shots fired from a M14 military assault rifle firing a 7.62 mm full metal copper jacket ball having a lead core (.308 caliber).

Without intending to be bound by theory, the inventor has conceived of a bullet-resistant door and bullet-resistant panel that has specifically been designed to combat the threat of high velocity military grade rifle ammunition and is rated at Level 8 on the UL 752 ballistic protection scale. These doors have also been extensively tested by the US Department of State, Bureau of Diplomatic Security and have attained high level of certification at 15R FEBR for a wooden door, DOS SD-STD-01.01 Rev H, 15 minute forced entry and rifle stopping protection level.

An aspect of the invention a bullet-resistant door is provided that is capable of withstanding projectiles having a UL 752—Level 8 rating. The design of the bullet-resistant door of the invention is such that it is extremely lightweight, especially in comparison to conventional bullet-resistant doors, and the bullet-resistant door of the invention is sized such that it can fit into a standard sized doorframe preventing the need for any retrofitting when using the bullet-resistant door of the invention to replace an existing door in a conventional frame.

The inventors have conceived of a novel and a unique design for a door and a panel allowing such door and panel to function as a bullet-resistant door and a bullet-resistant panel. The inventive design allows the bullet-resistant door and the bullet-resistant panel to meet or exceed UL 752—Level 6, UL 752—Level 7 or, preferably, UL 752—Level 8 standards. The bullet-resistant door and the bullet-resistant panel of the invention includes a frame design that allows a bullet-resistant panel to be supported within and form the core of the bullet-resistant door.

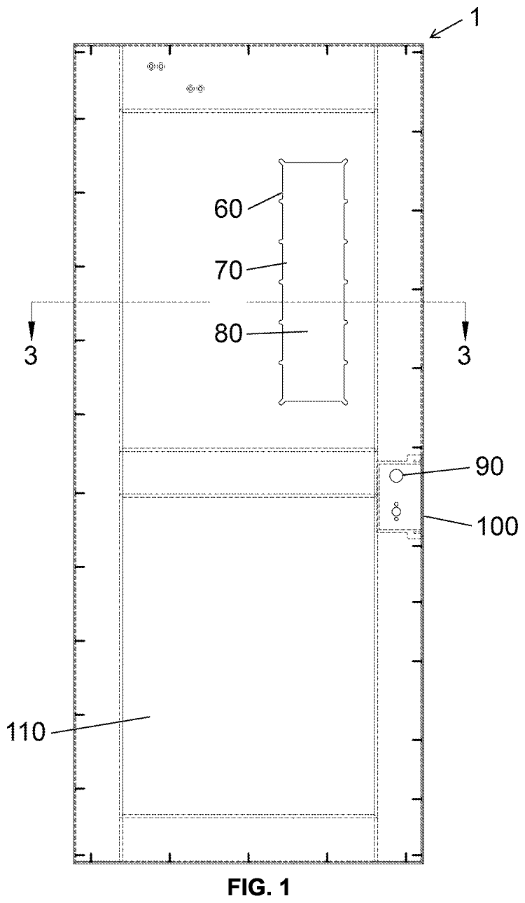

As shown in the exemplary embodiment of FIG. 1, the bullet-resistant door 1 may comprise a lite 70 including a bullet-resistant glass 80 and a window aperture 60 allowing an image to be projected through the bullet-resistant door 1 where the bullet-resistant glass 80 is placed. The bullet-resistant glass 80 is configured to match the window aperture 60 cutout. The exemplary embodiment of FIG. 1 includes face bores 90, which are holes included in the bullet-resistant door 1 through which a doorknob and trim may be placed. Additionally, an edge bore 100 may be included for a lock assembly.

A bullet-resistant door typically includes the inner core 110 as further shown in FIG. 1 for this exemplary embodiment of the bullet-resistant door 1 of the invention. Inner cores of conventional bullet-resistant doors may include any one of or any combination of a solid core layer of wood and wood core layers having a plastic laminate and honeycomb structured layers made of woven fibered or polymeric that may be additionally laminated each having lower levels of protection; solid metallic, such as steel, doors having higher levels of protection but an extremely heavy weight; fiberglass core layers such as comprising, for example, one or more fiberglass panels that are constructed of multiple layers of woven roving ballistic grade fiberglass cloth impregnated with a thermoset polyester resin and compressed into flat rigid sheets that tend to be limited on the number of projectiles that may be stopped; as well as others that suffer from similar limitations. However, the inner core 110 design of the bullet-resistant door 1 of the invention is what offers unique advantages such as a low weight and size as balanced against a higher level of ballistic protection.

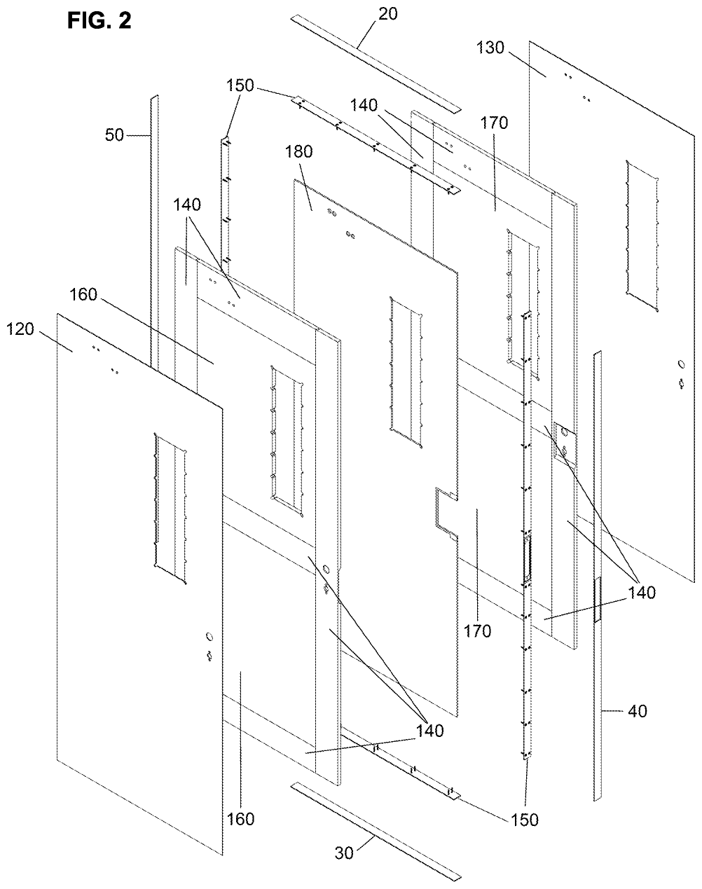

FIG. 2 is a perspective, deconstructed view of the assembly of a bullet-resistant door, according to an embodiment of the invention. Another aspect of the invention provides a method for manufacturing an bullet-resistant door. FIG. 2 both illustrates a structure of a bullet-resistant door, according to one embodiment of the invention, and shows the steps based upon the addition of various different components how such a bullet-resistant door may be manufactured.

The outer layers of the bullet-resistant door 1 of the exemplary embodiment of the invention of FIG. 2 includes a crossband veneer 120 and a diametrically opposed crossband veneer 130 on the opposite side of the door. The crossband veneer 120, 130, which may be replaced by other types of layers in certain embodiments of the invention, includes a second layer of veneer under a top layer of veneer with the grains of the two layers of veneer running opposite to each other. Such a configuration reinforces the top layer of veneer. In addition, the perimeter edges of the bullet-resistant door are comprised of a matching veneer (or other) layer, referred to as the top and bottom edge banding 20 & 30, respectively and the latch and hinge edge banding 40 & 50, respectively.

The sides of the bullet-resistant door 1 each additionally comprises layers that allow the bullet-resistant panel 180 to be secured horizontally and vertically within the inner core 110 of the bullet-resistant door 1. In the exemplary embodiment of FIG. 2, the bullet-resistant panel 180 is configured to have a shock-mitigating low-density balsa 160 and a diametrically opposed shock-mitigating low-density balsa 170 on the opposite side of the bullet-resistant panel 180. In this embodiment, the low-density balsa is surrounded by a structural natural material 140 to add stability. Without intending to be bound by theory, the shock-mitigating low-density balsas 160, 170 accommodate for any variations in the flat surface that may exist in the bullet-resistant panel and absorbs shock from ballistic impacts to the bullet-resistant core 180. In the exemplary embodiment of FIG. 2, the bullet-resistant panel 180 is captured within the structural natural material 140 using metallic perimeter strips 150 mechanically and/or adhesively fastened to the structural natural material 140 on both sides of the bullet-resistant core 180.

Material that may be used for the bullet-resistant panel 180 includes, but is not limited to, a bullet-resistant metal that may be included in a bullet-resistant layer configuration. In certain embodiments of the invention, the metal of the bullet-resistant panel 180 may comprise steel, aluminum, copper and any combination thereof.

In an embodiment of the invention, the bullet-resistant panel 180 may include a porous body of silicon carbide having open and through-penetrating pores that is prepared from a deformable mass of particles of silicon and carbon coated with an organic binder (SiC body). The pores of the body are filled with steel and/or a steel alloy under pressure of at least 1 bar followed by cooling. According to this embodiment of the invention, the silicon/steel composite is formed into the bullet-resistant panel 180 of the bullet-resistant door 1. In an embodiment of the invention, the porosity of the SiC body is from about 30% to about 70% and from about 40% to about 50% according to another embodiment of the invention. In certain embodiments of the invention, the pore size is up to about 500 μm. In other embodiments of the invention, the pore size ranges, on average, from about 5 μm to about 30 μm.

In yet another embodiment of the invention, the material of the bullet-resistant panel 180 comprises a manganese steel including from about 9 wt % to about 30 wt % manganese (Mn) and from about 1 wt % to about 4 wt % aluminum (Al). The manganese steel may optionally comprise any or any combination of up to about 6 wt % of silicon (Si), up to about 4 wt % copper (Cu), up to about 4% nickel (Ni) and up to about 1 wt % carbon (C). The remainder of the manganese steel comprises iron, preferably an iron alloy having other elements typically encountered therewith.

In certain other embodiments of the invention, the bullet-resistant panel 180 comprises a multilayer panel having a front-face bullet-resistant layer, a backing layer and the two layers joined via metallurgical bonding that includes a metallic based intermediate layer. Further pursuant to this embodiment of the invention, the layers are joined by using wide-area welding techniques, using technology of explosive cladding (high-velocity impact cladding), by roll welding or by a combination of these techniques.

In an embodiment of the invention, the front-face antiballistic layer is a hybrid metallic alloy containing 0.66 wt % of carbon, 0.40 wt % of silicone, 0.40 wt % of manganese, no more than about 0.010 wt % of phosphorus, no more than about 0.010 wt % of sulfur, 1.20 wt % of chromium, 0.20 wt % of nickel, 0.20 wt % of vanadium, 1.90 wt % of tungsten, while the remainder is iron, preferably an iron alloy having other elements typically encountered therewith. In certain other embodiments of the invention, the backing protective layer is a metallic alloy comprising 0.30 wt % of carbon, 1.60 wt % of silicone, 1.40 wt % of manganese, no more than about 0.010 wt % of phosphorus, no more than about 0.008 wt % of sulfur, 0.40 wt % of chromium, 1.20 wt % of nickel, the remainder is iron, preferably an iron alloy having other elements typically encountered therewith.

In certain embodiments of the invention, the metallic based intermediate layer is a face-centered cubic crystalline lattice comprising 71.0 wt % of nickel, 16.0 wt % of chromium, 3.0 wt % of manganese, 1.0 wt % of molybdenum, 2.0 wt % of niobium, 6.0 wt % of iron and other accompanying elements commonly encountered in these types of alloys.

In yet other embodiments of the invention, the bullet-resistant panel 180 comprises two or more layers comprising an aluminum alloy that are metallurgically bonded and then wrought.

The aluminum alloy compositions may include, in non-limiting examples, alloys of the AA series 1000, 2000, 3000, 4000, 5000, 6000, 7000, or 8000. In certain embodiments of the invention, the selected aluminum alloy includes from about 2 wt % to about 6 wt % of magnesium.

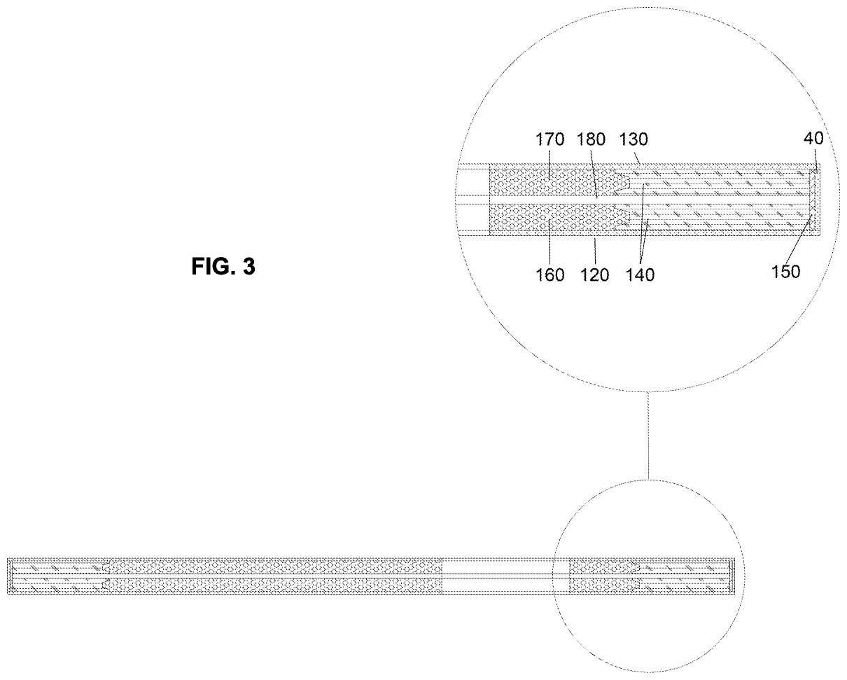

FIG. 3 is a cross-sectional view taken along line 3-3 in FIG. 1 showing interlayer construction of the bullet-resistant door, according to certain embodiments of the invention. FIG. 3 is included to show one possible configuration for a bullet-resistant door 1 that includes a lite 70. An enlarged call-out shown in FIG. 3 provides a detailed view of how the bullet-resistant panel 180 may be designed to fit in place with an assembly for the lite 70. A window aperture 60 is provided in the bullet-resistant panel 180 to secure the anti-ballistic glass 80 and the lite 70. The window aperture provided in the bullet-resistant panel 180 is carried through the low-density cores 60 & 70, the structural natural material 140, and the crossband veneers (or other) 120 & 130 to provide additional support to the anti-ballistic glass 80 and the lite 70.

The bullet-resistant doors may come in different sizes, colors, patterns, finishes and varying models supporting, in particular, an intended use of the bullet-resistant door. For example, as further described herein, the bullet-resistant door may include any of the elements commonly found in doors including, without limitation, bevel, camming, casing, composite panels, fiberglass core layer(s), joinery, keying, handing, sill, door swing, weather strip and the like.

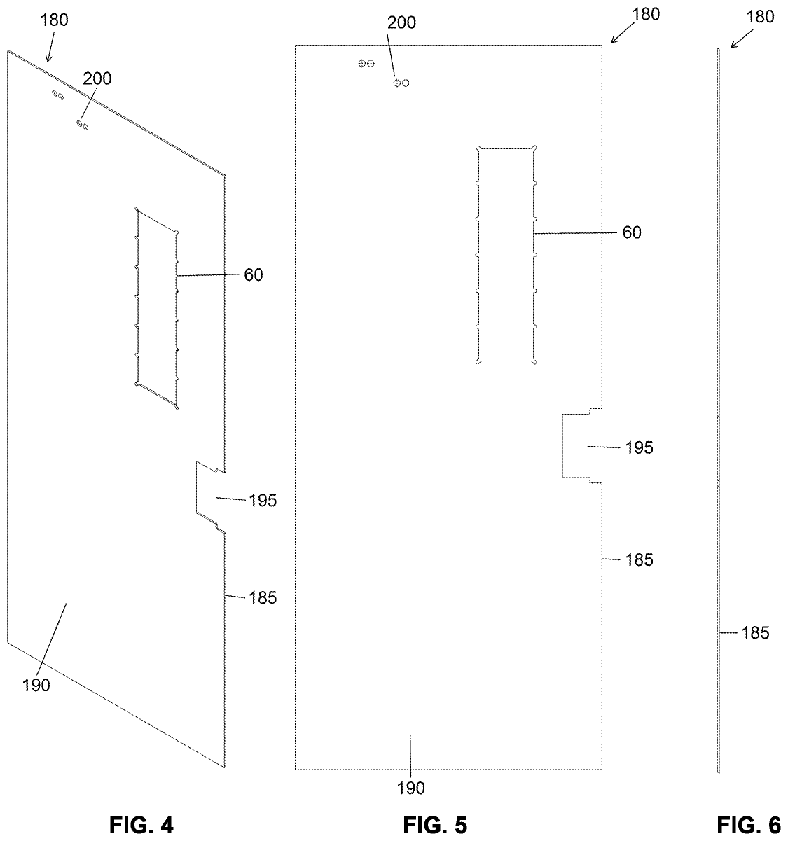

FIG. 4 is a three-dimensional view of a bullet-resistant panel according to an embodiment of the invention. A bullet-resistant panel 180, can be shaped to include the window aperture 60. The bullet-resistant panel 180 of FIG. 5 includes a strike face 190. The exemplary bullet-resistant panel 180 of FIG. 4 is shaped to also include a bore aperture 195 to accommodate the bores for the handle and, optionally, a lock, and a bore closure aperture 200 to accommodate a closing apparatus on doors configured to have such mechanisms. FIG. 5 is a front view of the bullet-resistant panel according to an embodiment of the invention; and FIG. 6 is a side view of the bullet-resistant panel according to an embodiment of the invention showing the door armor side 185 of the bullet-resistant panel 180. A thickness of the bullet-resistant panel 180 as measured by the width of the door armor side 185 illustrated in FIG. 12 is sized to allow the bullet-resistant door or bullet-resistant panel to meet the desired protection level to be achieved according to the UL 752 standard. The types of material and fabrication of the bullet-resistant panel 180 determines how thick the bullet-resistant panel 180 must be to ensure it meets the desired UL 752 standard.

In an embodiment of the invention, the material and fabrication of the bullet-resistant panel 180 is such that the thickness of the bullet-resistant panel 180 is 5.0 mm (0.196 in.) to about 10 mm (0.385 in.), from about 5.0 mm (0.196 in) to about 7.5 mm (0.295 in.), from about 5.0 mm (0.196 in.) to about 6 mm (0.254 in.), from about 5.0 mm (0.196 in.) to about 5.5 mm (0.22 in.), or from about 5.2 mm (0.204 in.) to about 5.4 mm (0.21 in.). In certain constructions, the sheet used for the bullet-resistant panel 180 may have variability in its thickness. Pursuant to these situations, the recited numbers represent an average width of the bullet-resistant panel 180.

In certain embodiments of the invention the bullet-resistant panel is finished to remove all burrs and ensure that any sharp edges are broken to allow the bullet-resistant panel 180 to be safe to touch. In certain embodiments of the invention, the surfaces of the bullet-resistant panel may be sand blasted to remove mill scale, and/or grease/oil residue on such surface. In still other embodiments of the invention, a primer may be applied to the surfaces of the bullet-resistant panel. In yet other embodiments of the invention, in the event the plate of the bullet-resistant panel develops excessive form after cutting, the bullet-resistant panel may be flattened prior to further processing and use.

The method of manufacturing the bullet-resistant door additionally may comprise providing a shock-mitigating low-density balsa and structural natural materials 140 that are adhesively bonded to the bullet-resistant panel. Optionally, the method of manufacturing a bullet-resistant door may include the step of inserting a bullet-resistant glass in an aperture of the bullet-resistant door to define a lite.

In certain embodiments of the invention, the structural natural materials 140 in the core of the door will be joined on the edges with perimeter metal strips 150 through mechanical and/or adhesive fastening. In this embodiment, the perimeter metal strips 150 will be further covered with edge banding 20, 30, 40, & 50 to match in material and aesthetics to the crossband veneers 120 & 130 as described above.

Many modifications and other embodiments of the invention set forth herein will come to mind to one skilled in the art to which this invention pertains having the benefit of the teachings presented in the descriptions herein. It will be appreciated by those skilled in the art that changes could be made to the embodiments described herein without departing from the broad inventive concept thereof. Therefore, it is understood that this invention is not limited to the particular embodiments disclosed, but it is intended to cover modifications within the spirit and scope of the present invention as defined by the included claims.

That which is claimed:

1. A bullet-resistant door comprising
a layered assembly substantially defining an inner perimeter of the door;
a bullet-resistant panel secured internal to the door using the layered assembly,
wherein the bullet-resistant door having at least a UL 752—Level 8 protection.

2. The bullet-resistant door of claim 1, additionally comprising a shock-mitigating layer and a diametrically opposed shock-mitigating layer covering both sides of the bullet-resistant panel.

3. The bullet-resistant door of claim 2, where the shock-mitigating layer and the diametrically opposed shock-mitigating layer comprise a low-density balsa.

4. The bullet-resistant door of claim 3, wherein the shock-mitigating low-density balsa and the diametrically opposed shock-mitigating low-density balsa are adhesively bonded to the bullet-resistant panel.

5. The bullet-resistant door of claim 3, wherein the shock-mitigating low-density balsa and the diametrically opposed shock-mitigating low-density balsa are each surrounded by a structural natural material.

6. The bullet-resistant door of claim 1, additionally comprising a lite.

7. The bullet-resistant door of claim 6, wherein the bullet-resistant door additionally comprising an aperture where a bullet-resistant glass is inserted to define the lite.

8. The bullet-resistant door of claim 1, additionally comprising a panel and a diametrically opposed panel each having a veneer layer.

9. The bullet-resistant door of claim 8, wherein the veneer layer comprises a crossband veneer layer having a second layer of veneer under a top layer of veneer with the grains of the second layer of veneer running opposite to the top layer of veneer.

10. The bullet-resistant door of claim 1, wherein the bullet-resistant panel having a material comprising a manganese steel including from about 9 wt % to about 30 wt % manganese (Mn) and from about 1 wt % to about 4 wt % aluminum (Al).

11. The bullet-resistant door of claim 10, wherein the manganese steel additionally comprising any one of or any combination of up to about 6 wt % of silicon (Si), up to about 4 wt % copper (Cu), up to about 4% nickel (Ni) and up to about 1 wt % carbon (C), wherein the remainder of the manganese steel comprises an iron alloy.

12. The bullet-resistant door of claim 1, wherein the bullet-resistant panel comprising a plurality of layers including a front-face bullet-resistant layer and a backing layer, wherein the front-face bullet-resistant layer and the backing layer are joined by metallurgical bonding that includes a metallic based intermediate layer.

13. The bullet-resistant door of claim 12, wherein the plurality of layers joined by using in one of or any combination of a wide-area weld, an explosive cladding, and roll weld.

14. The bullet-resistant door of claim 12, wherein the front-face antiballistic layer is a hybrid metallic alloy comprising about 0.66 wt % of carbon, about 0.40 wt % of silicone, about 0.40 wt % of manganese, no more than about 0.010 wt % of phosphorus, no more than about 0.010 wt % of sulfur, about 1.20 wt % of chromium, about 0.20 wt % of nickel, about 0.20 wt % of vanadium, about 1.90 wt % of tungsten with the remainder being an iron alloy.

15. The bullet-resistant door of claim 12, wherein the backing protective layer is a metallic alloy comprising 0.30 wt % of carbon, 1.60 wt % of silicone, 1.40 wt % of manganese, no more than about 0.010 wt % of phosphorus, no more than about 0.008 wt % of sulfur, 0.40 wt % of chromium, 1.20 wt % of nickel, the remainder is an iron alloy.

16. The bullet-resistant door of claim 12, wherein the metallic based intermediate layer having a face-centered cubic crystalline lattice construction comprising alloys about 71.0 wt % of nickel, about 16.0 wt % of chromium, about 3.0 wt % of manganese, about 1.0 wt % of molybdenum, about 2.0 wt % of niobium, about 6.0 wt % of iron.

17. The bullet-resistant door of claim 1, wherein the bullet-resistant door having a UL 752 —Level 8 protection.

18. A bullet-resistant panel comprising a layered assembly substantially defining an inner perimeter of the panel, where the layered assembly having
a bullet-resistant panel secured internally using the using layers of shock-mitigating materials, pre-machined wood panels and door veneers and
at least UL 752—Level 6 protection.

19. A method of manufacturing a bullet-resistant door comprising:
providing a bullet-resistant panel;
securing both sides of the bullet-resistant panel with a shock-mitigating low-density balsa wood;
encapsulating the bullet-resistant panel and shock-mitigating low-density balsa wood between the two pre-machined wooden faces of the door;
securing both of the top and bottom edges using a pre-machined high strength metallic strips thus providing the doors with additional edge strength and anti-breach protection; and
finishing the bullet-resistant door with a laminated skin, wherein the bullet-resistant door provides a minimum UL 752—Level 8 protection.

20. The method of claim 19, additionally comprising inserting a bullet-resistant glass in an aperture of the bullet-resistant door to define a lite.
